(19) United States
(12) Patent Application Publication
(10) Pub. No.: US 2010/0084375 A1
(43) Pub. Date: Apr. 8, 2010

(54) METHOD OF PRODUCING A REFLECTIVE MASK

(75) Inventor: Morio HOSOYA, Shinjuku-ku (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION, Tokyo (JP)

(21) Appl. No.: 12/573,419

(22) Filed: Oct. 5, 2009

(30) Foreign Application Priority Data
Oct. 4, 2008 (JP) 2008-259138
Sep. 16, 2009 (JP) 2009-214524

(51) Int. Cl. B44C 1/22

(52) U.S. Cl. 216/24

(57) ABSTRACT

A method of producing a reflective mask is carried out by the use of a reflective mask blank which has a substrate, a multilayer reflective film formed on the substrate to reflect exposure light, a protective film formed on the multilayer reflective film, a buffer film formed on the protective film, and an absorber film formed on the buffer film to absorb the exposure light. The protective film is made of a ruthenium compound containing Ru and Nb. The method includes a step of patterning the buffer film by dry etching performed by the use of an etching gas containing oxygen.

This application is based upon and claims the benefit of priority from Japanese Patent Application No. 2008-259138, filed on Oct. 4, 2008, and Japanese Patent Application No. 2009-214524, filed on Sep. 16, 2009, the disclosures of which are incorporated herein in their entirety by reference.

### BACKGROUND OF THE INVENTION

This invention relates to a method of producing a reflective mask for exposure which is for use in manufacture of a semiconductor device and the like.

In recent years, the advance of miniaturization of semiconductor devices awakens expectations of using EUV lithography as an exposure technique using extreme ultra violet (hereinafter abbreviated to EUV) light in the semiconductor industry. Herein, the EUV light represents light in a wavelength band of a soft X-ray region or a vacuum ultraviolet region and, specifically, light having a wavelength of approximately 0.2 to 100 nm. As a mask for use in the EUV lithography, a reflective mask for exposure is proposed, for example, in JP-B-H07-27198 (Patent Document 1).

The reflective mask of the type comprises a substrate, a multilayer reflective film formed on the substrate to reflect exposure light, and a patterned absorber film formed on the multilayer reflective film to absorb the exposure light. The exposure light incident to the reflective mask mounted to an exposure apparatus (pattern transfer apparatus) is absorbed in an area where the absorber film is present. On the other hand, in another area where the absorber film is not present, the exposure light is reflected by the multilayer reflective film to form an optical image which is transferred onto a semiconductor substrate through a reflective optical system.

As the above-mentioned multilayer reflective film, for example, which is adapted to reflect the EUV light having a wavelength of 13 to 14 nm, there is known a multilayer film comprising Mo and Si thin films each having a thickness of several nanometers and alternately laminated in about 40 to 60 cycles or periods, as shown in FIG. 3. In order to increase a reflectance of the multilayer reflective film, it is desired that the Mo film having a high refractive index is located at an uppermost layer. However, Mo at the uppermost layer is easily oxidized in contact with air. This results in decrease in reflectance. In view of the above, the Si film is located at the uppermost layer to serve as a protective film for preventing oxidation.

JP-A-2002-122981 (Patent Document 2) discloses a reflective mask comprising a multilayer reflective film composed of Mo films and Si films alternately laminated, an absorber pattern formed on the multilayer film, and a buffer layer of ruthenium (Ru) formed between the multilayer reflective film and the absorber pattern.

### SUMMARY OF THE INVENTION

In Patent Document 1, the Si film is located at the uppermost layer as the protective film. In this case, if the Si film is thin, a sufficient anti-oxidation effect is not achieved. Therefore, the Si film generally has a large thickness sufficient to prevent oxidation. However, since the Si film slightly absorbs the EUV light, the large thickness of the Si film disadvantageously results in decrease of the reflectance.

Patent Document 2 discloses the Ru film formed between the multilayer reflective film and the absorber pattern. However, the Ru film is disadvantageous in the following respects.

(1) The multilayer reflective film of the reflective mask is required to withstand an environment during pattern formation of the absorber film or during pattern formation of the buffer film formed between the multilayer reflective film and the absorber film. Thus, upon selection of a material of the protective film formed on the multilayer reflective film, it is also required to consider a condition that a high etching selectivity is assured with respect to the absorber film or the buffer film.

For example, in case where a Ta-based material is used as the absorber film, a Cr-based buffer film may be formed in order to prevent an etching damage of the multilayer reflective film during pattern formation. After the absorber film is patterned, the Cr-based buffer film is patterned according to the absorber pattern. Generally, the Cr-based buffer film is patterned by dry etching performed by the use of an oxygen-added chlorine-based gas. The above-mentioned Ru protective film is low in etching resistance particularly against an oxygen-added chlorine-based gas containing 70% or more oxygen. This results in occurrence of damage in the multilayer reflective film to cause decrease in reflectance.

(2) In a production process of a reflective mask using the reflective mask blank or in use of the reflective mask, cleaning is repeatedly performed by the use of various chemicals. Therefore, not only the absorber film but also the protective film formed on the multilayer reflective film to protect the multilayer reflective film desirably has an excellent chemical resistance.

However, the Ru protective film is low in resistance against ozone-water cleaning to be performed upon occurrence of haze in the reflective mask and, therefore, can not sufficiently be cleaned. It is therefore desired to improve the chemical resistance of the protective film formed on the multilayer reflective film.

It is therefore an object of this invention to provide a method of producing a reflective mask having a protective film which is formed on a multilayer reflective film and which is excellent in resistance against an environment during pattern formation of a buffer film formed on the multilayer reflective film and excellent in chemical resistance during cleaning or the like.

In order to solve the above-mentioned problems, this invention has following structures.

(Structure 1)

A method of producing a reflective mask using a reflective mask blank comprising a substrate, a multilayer reflective film formed on the substrate to reflect exposure light, a protective film formed on the multilayer reflective film to protect the multilayer reflective film, a buffer film formed on the protective film and made of a material etchable during dry etching performed by the use of an etching gas containing an oxygen gas, and an absorber film formed on the buffer film to absorb the exposure light, wherein the protective film is made of a ruthenium compound containing ruthenium (Ru) and niobium (Nb); the method including a step of patterning the buffer film by dry etching performed by the use of the etching gas containing the oxygen gas.

In the structure 1, the protective film is made of the ruthenium compound containing ruthenium (Ru) and niobium (Nb). The method includes the step of patterning the buffer film formed on the protective film by dry etching performed by the use of the etching gas containing the oxygen gas. Therefore, it is possible to obtain the reflective mask which has the following effects.

(1) The buffer film is formed on the protective film and made of a material etchable during dry etching performed by the use of the etching gas containing the oxygen gas. By the step of patterning the buffer film by dry etching performed by the use of the etching gas containing the oxygen gas, an oxidized layer containing Nb as a main component is formed on a surface of the protective film. The oxidized layer exhibits a function as an etching stopper and, as a result, the protective film has an excellent resistance against a dry etching environment of the buffer film. Therefore, the multilayer reflective film is not damaged during patterning of the buffer film. Accordingly, no decrease in reflectance of the multilayer reflective film is caused to occur.

(2) By the step of patterning the buffer film formed on the protective film by dry etching performed by the use of the etching gas containing the oxygen gas, the oxidized layer containing Nb as a main component is formed on the surface of the protective film. The above-mentioned protective film is excellent in chemical resistance during cleaning in a production process of the reflective mask or in use of the reflective mask. In particular, the above-mentioned protective film is high in resistance against ozone-water cleaning to be performed upon occurrence of haze in the reflective mask so that cleaning can sufficiently be carried out. Therefore, no decrease in reflectance within a reflection region for the exposure light is caused to occur.

(Structure 2)

A method according to structure 1, wherein the protective film has a thickness within a range between 0.8 nm and 5 nm.

Preferably, the thickness of the protective film in this invention is selected within a range between 0.8 nm and 5 nm as in the structure 2. If the thickness is smaller than 0.8 nm, various kinds of resistances required as the protective film may not be obtained. On the other hand, if the thickness is greater than 5 nm, an EUV absorbance of the protective film may be increased to decrease the reflectance on the multilayer reflective film.

(Structure 3)

A method according to structure 1 or 2, wherein the buffer film is made of a chromium-based material containing chromium (Cr).

The buffer film made of the chromium-based material as in the structure 3 can be easily etched during dry etching performed by the use of a mixed gas of oxygen and a chlorine-based gas and has a high smoothness. Further, a surface of the absorber film formed thereon also has a high smoothness. Therefore, pattern blurring is reduced.

(Structure 4)

A method according to structure 3, wherein the buffer film is made of a material containing chromium nitride (CrN) as a main component.

In this invention, it is preferable that the material containing chromium nitride (CrN) as a main component is used as the buffer film as in the structure 4.

(Structure 5)

A method according to any one of structures 1 through 4, wherein the absorber film is made of a tantalum-based material containing tantalum (Ta)

In this invention, it is preferable the tantalum-based material containing tantalum (Ta) is used as the absorber film as in the structure 5.

(Structure 6)

A method according to any one of structures 1 though 5, wherein the etching gas containing the oxygen gas is a mixed gas of a chlorine-based gas and the oxygen gas.

In this invention, it is preferable that the buffer film of a chromium-based material is etched by the use of the mixed gas of a chlorine-based gas and the oxygen gas as in the structure 6.

According to this invention, it is possible to provide a method of producing a reflective mask having a protective film which is formed on a multilayer reflective film and which is excellent in resistance against an environment during pattern formation of a buffer film formed on the multilayer reflective film and excellent in chemical resistance during cleaning or the like.

### BRIEF DESCRIPTION OF THE DRAWING

FIGS. 1A to 1D are sectional views for describing a structure of a reflective mask blank according to an embodiment of this invention and a process of producing a reflective mask by using the mask blank;

FIG. 2 is a schematic view of a pattern transfer apparatus with the reflective mask mounted thereto; and

FIG. 3 is a sectional view of a conventional periodic Mo/Si multilayer reflective film.

### DESCRIPTION OF THE EXEMPLARY EMBODIMENT

Now, an embodiment of this invention will be described in detail with reference to the drawing.

A reflective mask blank for use in this invention comprises a substrate, a multilayer reflective film formed on the substrate to reflect exposure light, a protective film formed on the multilayer reflective film to protect the multilayer reflective film, a buffer film formed on the protective film and made of a material etchable during dry etching performed by the use of an etching gas containing an oxygen gas, and an absorber film formed on the buffer film to absorb the exposure light. The protective film is made of a ruthenium compound containing ruthenium (Ru) and niobium (Nb).

By a method using the above-mentioned mask blank and including the step of patterning the buffer film formed on the protective film by dry etching performed by the use of the etching gas containing the oxygen gas, the reflective mask having the following effects is obtained.

(1) The buffer film is formed on the protective film and made of a material etchable during dry etching performed by the use of the etching gas containing the oxygen gas. By the step of patterning the buffer film by dry etching performed by the use of the etching gas containing the oxygen gas, an oxidized layer containing Nb as a main component is formed on a surface of the protective film. The oxidized layer exhibits a function as an etching stopper and, as a result, the protective film has an excellent resistance against a dry etching environment of the buffer film. Therefore, the multilayer reflective film is not damaged during patterning of the buffer film. Accordingly, no decrease in reflectance of the multilayer reflective film is caused to occur.

(2) By the step of patterning the buffer film formed on the protective film by dry etching performed by the use of the etching gas containing the oxygen gas, the oxidized layer containing Nb as a main component is formed on the surface of the protective film. The above-mentioned protective film is excellent in chemical resistance during cleaning in a production process of the reflective mask or in use of the reflective mask. In particular, the above-mentioned protective film is high in resistance against ozone-water cleaning to be performed upon occurrence of haze in the reflective mask so that cleaning can sufficiently be carried out. Therefore, no decrease in reflectance within a reflection region for the exposure light is caused to occur.

In this invention, a typical ruthenium compound as a material of the protective film is, for example, RuNb.

In order to fully exhibit the above-mentioned effects, the content of Ru in the ruthenium compound is preferably within a range between 10 and 95 atomic %. In particular, in order to improve the above-mentioned effect (1) (to improve the dry etching resistance), the content of Ru in the ruthenium compound is desirably within a range between 50 and 90 atomic %. In order to improve the above-mentioned effect (2) (to improve the chemical resistance), the content of Ru in the ruthenium compound is desirably within a range between 70 and 85 atomic %.

The thickness of the protective film in this invention is preferably selected within a range between 0.8 nm and 5 nm. If the thickness of the protective film is smaller than 0.8 nm, various kinds of resistances required as the protective film may not be obtained. On the other hand, if the thickness is greater than 5 nm, the EUV absorbance of the protective film may be increased to decrease the reflectance on the multilayer reflective film. More preferably, the protective film has a thickness such that the reflectance on the multilayer reflective film is maximized.

Preferably, the protective film in this invention is made of RuNb. The oxidized layer containing Nb as a main component is formed on the surface of the protective film. With this structure, the dry etching resistance or the chemical resistance is more effectively exhibited.

The protective film in this invention may contain nitrogen (N). The protective film containing nitrogen is desirable because film stress is decreased while adhesion between the protective film and the multilayer reflective film or the buffer film is improved. The content of nitrogen is preferably within a range between 2 and 30 atomic %, more preferably within a range between 5 and 15 atomic %.

The above-mentioned protective film need not have a uniform composition throughout the entire film. For example, the protective film may have a composition gradient such that a composition is different in a thickness direction. In case where the protective film has the composition gradient, the composition of elements contained in the protective film may be different either continuously or stepwise. In this case, the composition gradient such that Nb is rich on a surface adjacent to the absorber film is preferable.

In the reflective mask blank for use in this invention, the buffer film different in etching property from the absorber film may be formed between the protective film and the absorber film. By forming the buffer film, the multilayer reflective film is prevented from being damaged by etching during pattern formation and pattern correction of the absorber film. The buffer film is made of the material etchable during dry etching performed by the use of the etching gas containing the oxygen gas. In particular, the buffer film made of a chromium-based material containing chromium can be etched during dry etching performed by the use of the mixed gas of oxygen and the chlorine-based gas and has a high smoothness. Further, the surface of the absorber film formed thereon also has a high smoothness. Therefore, pattern blurring is reduced.

As a material of the chromium-based buffer film, use may be made of an elemental substance of chromium (Cr) or a material containing chromium (Cr) and at least one kind of element selected from a group consisting of nitrogen (N), oxygen (O), carbon (C), and fluorine (F). For example, the buffer film containing nitrogen is excellent in smoothness. The buffer film containing carbon is improved in etching resistance under a dry etching condition of the absorber film. The buffer film containing oxygen is reduced in film stress. Specifically, CrN, CrO, CrC, CrF, CrON, CrCO, CrCON, or the like is preferably used as the material of the buffer film.

In the mixed gas of oxygen and the chlorine-based gas for use in dry etching the chromium-based buffer film, the chlorine-based gas may be, for example, Cl₂, SiCl₄, HCl, CCl₄, CHCl₃, or BCl₃.

The reflective mask blank may be provided with a resist film for use in forming a predetermined transfer pattern by patterning the absorber film.

According to an aspect of this invention, the reflective mask obtained by using the above-mentioned reflective mask blank comprises a substrate, a multilayer reflective film formed on the substrate, a protective film formed on the multilayer reflective film, a buffer film pattern formed on the protective film and having a predetermined transfer pattern, and an absorber film pattern formed on the buffer film and having the predetermined transfer pattern.

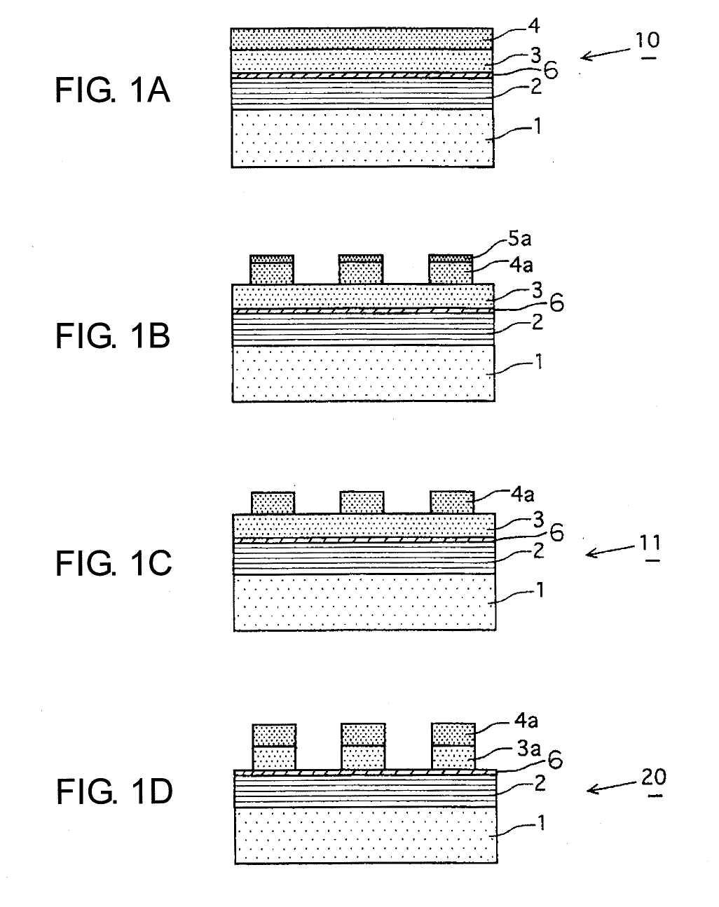

FIGS. 1A to 1D are schematic sectional views for describing a reflective mask blank for use in one embodiment of this invention and a process of producing a reflective mask by using the reflective mask blank.

Referring to FIG. 1A, the reflective mask blank 10 for use in this invention comprises a substrate 1, a multilayer reflective film 2 formed on the substrate 1, a protective film 6 formed on the multilayer reflective film 2, a buffer film 3 formed on the protective film 6, and an absorber film 4 formed on the buffer film 3.

In order to prevent pattern distortion due to heat generation during exposure, the substrate 1 preferably has a low coefficient of thermal expansion within a range of 0±1.0×10⁻⁷/° C., more preferably within a range of 0±0.3×10⁻⁷/° C. As a material having a low coefficient of thermal expansion within the above-mentioned range, use may be made of an amorphous glass, a ceramic, or a metal. For example, the amorphous glass may be a SiO₂—TiO₂ glass or a quartz glass while a crystallized glass may be a crystallized glass in which a β-quartz solid solution is precipitated. As an example of a metal substrate, use may be made of an Invar alloy (Fe—Ni alloy). Alternatively, a single-crystal silicon substrate may be used.

In order to achieve a high reflectance and a high transfer accuracy, the substrate 1 preferably has a high smoothness and a high flatness. In particular, the substrate 1 preferably has a smooth surface having a smoothness of 0.2 nmRms or less (smoothness in a 10 μm square area) and a flatness of 100 nm or less (flatness in a 142 mm square area). In order to prevent deformation due to a film stress of a film formed thereon, the substrate 1 preferably has a high stiffness or rigidity. In particular, the substrate 1 preferably has a high Young's modulus of 65 GPa or more.

It is noted here that the unit Rms representative of the smoothness is a root mean square roughness which can be measured by an atomic force microscope. On the other hand, the flatness is a value indicative of surface warp (deformation) given by TIR (Total Indicated Reading) and is an absolute value of a difference in height between the highest position and the lowest position of a substrate surface located above and below a focal plane, respectively, where the focal plane is a plane determined by the least square method with reference to the substrate surface.

As described above, the multilayer reflective film 2 is a multilayer film comprising a plurality of elements different in refractive index from one another and cyclically or periodically laminated. Generally, use is made of a multilayer film comprising thin films of a heavy element or a compound thereof and thin films of a light element or a compound thereof which are alternately laminated in about 40 to 60 cycles or periods.

For example, as a multilayer reflective film for EUV light having a wavelength between 13 and 14 nm, use is preferably made of the above-mentioned periodic Mo/Si multilayer film comprising Mo and Si thin films alternately laminated in about 40 periods. As a multilayer reflective film for use in an EUV region, use may also be made of a periodic Ru/Si multilayer film, a periodic Mo/Be multilayer film, a periodic Mo-compound/Si-compound multilayer film, a periodic Si/Nb multilayer film, a periodic Si/Mo/Ru multilayer film, a periodic Si/Mo/Ru/Mo multilayer film, a periodic Si/Ru/Mo/Ru multilayer film, or the like. Depending on an exposure wavelength, the material of the multilayer reflective film 2 is appropriately selected.

The multilayer reflective film 2 may be formed by depositing respective layers using DC magnetron sputtering, ion beam sputtering, or the like. For example, the above-mentioned periodic Mo/Si multilayer film may be formed in the following manner. By ion beam sputtering, a Si film having a thickness of several nanometers is at first deposited by using a Si target. Then, using a Mo target, a Mo film having a thickness of several nanometers is deposited. A combination of the Si film of several nanometers and the Mo film of several nanometers is defined as a single period. In the above-mentioned manner, these films are laminated in 40 to 60 periods. Finally, in order to protect the multilayer reflective film, the protective film using the material according to this invention is formed.

As the buffer film 3, the above-mentioned chromium-based buffer film which can be etched during dry etching performed by the use of the mixed gas of oxygen and the chlorine-based gas is preferably used. The buffer film 3 may be formed on the protective film by sputtering such as DC sputtering, RF sputtering, and ion beam sputtering.

The buffer film 3 preferably has a thickness within a range between 20 and 60 nm in case where the absorber film pattern is corrected by using a focused ion beam (FIB), but may be within a range between 5 and 15 nm in case where the FIB is not used.

Next, the absorber film 4 has a function of absorbing the exposure light, for example, the EUV light. As the absorber film 4, use is preferably made of an elemental substance of tantalum (Ta) or a material containing Ta as a main component. Generally, the material containing Ta as a main component is a Ta alloy. The absorber film preferably has an amorphous structure or a microcrystal structure in view of the smoothness and the flatness.

As the material containing Ta as a main component, use may be made of a material containing Ta and B, a material containing Ta and N, a material containing Ta, B, and at least one of O and N, a material containing Ta and Si, a material containing Ta, Si, and N, a material containing Ta and Ge, a material containing Ta, Ga, and N, and so on. By addition of B, Si, Ge, or the like to Ta, an amorphous material is easily obtained so as to improve the smoothness. On the other hand, by addition of N or O to Ta, oxidation resistance is improved so that an effect of improving stability over time is obtained.

Among others, the material containing Ta and B (the composition ratio Ta/B falling within a range between 8.5/1.5 and 7.5/2.5) and the material containing Ta, B, and N (the content of N being 5 to 30 atomic % and, with respect to the balance assumed as 100 atomic %, the ratio of B being 10 to 30 atomic %) are particularly preferable. In case of these materials, a microcrystal structure or an amorphous structure is easily obtained so as to achieve an excellent smoothness and an excellent flatness.

Preferably, the absorber film consisting of an elemental substance of Ta or containing Ta as a main component is formed by sputtering such as magnetron sputtering. For example, a TaBN film may be deposited by sputtering using a target containing tantalum and boron and a nitrogen-added argon gas. When the absorber film is formed by sputtering, an internal stress can be controlled by changing a power supplied to the sputtering target or a pressure of the gas supplied. Furthermore, since the absorber film can be formed at a low temperature such as a room temperature, it is possible to reduce an influence of heat upon the multilayer reflective film and other films.

As the absorber film, a material such as WN, TiN, or Ti may be used instead of the material containing Ta as a main component.

The absorber film 4 may have a multilayer structure comprising a plurality of layers different in material or composition.

The absorber film 4 must have a thickness such that the exposure light, such as the EUV light, is sufficiently absorbed. Generally, the absorber film 4 has a thickness within a range between 30 and 100 nm.

Next, description will be made about the process of producing the reflective mask using the reflective mask blank 10 according to this invention.

Each of the layers of the reflective mask blank 10 (see FIG. 1A) is formed by using the material and the method described above.

By patterning the absorber film 4 of the reflective mask blank 10, a predetermined transfer pattern is formed. At first, a resist for electron beam lithography (EB resist) is applied on the absorber film 4 and baked. Next, using an electron beam writer, predetermined pattern writing is performed. Then, development is performed to form a predetermined resist pattern 5a.

Using the resist pattern 5a as a mask, the absorber film 4 is dry-etched to form an absorber film pattern 4a having a predetermined transfer pattern (see FIG. 1B). In case where the absorber film 4 is made of a material containing Ta as a main component, dry etching with a chlorine gas may be used.

Then, the resist pattern 5a left on the absorber film pattern 4a is removed by using a hot concentrated sulfuric acid to produce a mask 11 (see FIG. 1C).

Generally, the mask 11 is subjected to inspection to detect whether or not the absorber film pattern 4a is formed exactly as designed. In the inspection of the absorber film pattern 4a, for example, DUV (deep ultraviolet) light having a wavelength within a range between 190 nm and 260 nm is used as inspection light. The inspection light is incident to the mask 11 having the absorber film pattern 4a. Herein, the inspection is performed by detecting the inspection light reflected on the absorber film pattern 4a and the inspection light reflected by the buffer film 3 exposed after the absorber film 4 is partly removed and observing the contrast therebetween.

In the above-mentioned manner, for example, a pinhole defect (white defect) and an underetching (insufficient etching) defect (black defect) are detected. The pinhole defect (white defect) is caused by undesired removal of a necessary part of the absorber film which should not be removed. The underetching defect (black defect) is an unnecessary part of the absorber film which is undesirably left due to underetching. If the pinhole defect or the underetching defect is detected, the defect is corrected.

In order to correct the pinhole defect, for example, use may be made of a method of depositing a carbon film or the like in a pinhole by FIB (Focused Ion Beam)-assisted deposition. In order to correct the underetching defect, use may be made of a method of removing the unnecessary part by FIB irradiation. In this case, the buffer film 3 serves as a protective film for protecting the multilayer reflective film 2 against the FIB irradiation.

After completion of the pattern inspection and the pattern correction of the absorber film pattern 4a, an exposed part of the buffer film 3 is removed by dry etching according to the absorber film pattern 4a to form a buffer film pattern 3a on the buffer film 3. Thus, a reflective mask 20 is produced (see FIG. 1D). For example, in case of the buffer film 3 made of a Cr-based material, dry etching may be performed by the use of a mixed gas containing oxygen and a chlorine-based gas. As regards a content of oxygen included within the mixed gas of oxygen and the chlorine-based gas, the content of oxygen is preferably rich within a range in which the dry etching performance of the Cr-based buffer film is not adversely influenced, in view of forming the oxidized layer on the surface of the protective film exposed as a result of removing the buffer film 3 by etching. Therefore, in this invention, the oxygen content in the mixed gas of oxygen and the chlorine-based gas is preferably selected so that Cl₂:O₂=4:1. In an area where the buffer film 3 is removed, the multilayer reflective film 2 as a reflection region for the exposure light is exposed. On the multilayer reflective film 2 thus exposed, the protective film 6 made of a protective film material according to this invention is formed. On the surface of the protective film 6, the oxidized layer containing, as a main component, Nb in the ruthenium compound constituting the protective film 6 is formed by dry etching of the buffer film 3 to further improve the etching resistance of the protective film 6 against the dry etching. At this time, the protective film 6 serves to protect the multilayer reflective film 2 against dry etching of the buffer film 3.

Finally, final inspection is carried out to confirm whether or not the absorber film pattern 4a is formed in a dimensional accuracy according to specifications. Also in the final inspection, the above-mentioned DUV light is used.

The reflective mask produced by using the reflective mask blank according to this invention is particularly advantageous when the EUV light (having a wavelength in a range between 0.2 and 100 nm) is used as the exposure light. However, the reflective mask may be appropriately used for light having a different wavelength.

### EXAMPLES

Hereinafter, the embodiment of this invention will be described more in detail with reference to specific examples.

### Example 1

A SiO₂—TiO₂ glass substrate (6-inch square, 6.3 mm thick) was used as a substrate. The glass substrate had a coefficient of thermal expansion of 0.2×10⁻⁷/° C. and a Young's modulus of 67 GPa. The glass substrate was polished by mechanical polishing to have a smooth surface of 0.2 nmRms or less and a flatness of 100 nm or less.

As a multilayer reflective film formed on the substrate, a periodic Mo/Si multilayer reflective film was used so as to be suitable for an exposure wavelength band between 13 and 14 nm. Specifically, the multilayer reflective film was formed by alternately laminating Mo and Si films on the substrate by ion beam sputtering using a Mo target and a Si target. Herein, a combination of the Si film having a thickness of 4.2 nm and the Mo film having a thickness of 2.8 nm is defined as a single period. After these films were laminated in 40 periods, deposition of the Si film to a thickness of 4.2 nm was performed at an end of deposition of the multilayer reflective film. Finally, an RuNb film as a protective film was deposited to a thickness of 2.5 nm by using an RuNb target.

In the above-mentioned manner, a substrate with the multilayer reflective film was obtained. EUV light having a wavelength of 13.5 nm was incident to the multilayer reflective film at an incident angle of 6.0 degrees. Then, the reflectance was measured. As a result, the reflectance was 65.9%).

Next, on the protective film of the substrate with the multilayer reflective film obtained as mentioned above, a buffer film was formed. As the buffer film, a chromium nitride (CrNx) film was formed to a thickness of 20 nm. The CrNx film was deposited by DC magnetron sputtering using a Cr target and a mixed gas of argon (Ar) and nitrogen (N₂) as a sputtering gas. In the CrNx film thus deposited, the content of nitrogen (N) was 10 atomic % (x=0.1).

Next, on the buffer film, a TaBN film made of a material containing Ta, B, and N was formed as an absorber film to a thickness of 80 nm. Specifically, the TaBN film was deposited by DC magnetron sputtering using a target containing Ta and B and a sputtering gas containing argon (Ar) with 10% nitrogen (N₂) added thereto. The TaBN film thus deposited had a composition of 80 at % Ta, 10 at % B and 10 at % N.

Next, using the above-mentioned reflective mask blank, a reflective mask for EUV exposure, which has a pattern for a 16 Gbit-DRAM of a 0.07 μm design rule, was produced in the following manner.

At first, a resist film for electron beam lithography was formed on the above-mentioned reflective mask blank. By using an electron beam writer, predetermined pattern writing was performed. After the writing, development was performed to form a resist pattern.

Next, with the resist pattern used as a mask, the absorber film was dry-etched with a chlorine gas to form a transfer pattern as the absorber film pattern.

Furthermore, according to the absorber film pattern, the buffer film left on the reflection region (where no absorber film pattern was present) was removed by dry etching performed by the use of a mixed gas of chlorine and oxygen (the oxygen content being 20%) to thereby expose the multilayer reflective film having the protective film on its surface. Thus, the reflective mask was obtained. In case of the RuNb protective film (in this invention, the oxidized layer is formed on the surface of the protective film by the above-mentioned dry etching), the etching selectivity of the buffer film to the protective film is 20:1.

The reflective mask thus obtained was subjected to final inspection. As a result, it was confirmed that the pattern for the 16 Gbit-DRAM of the 0.07 μm design rule was formed exactly as designed. The reflectance for the EUV light in the reflection region where the multilayer reflective film having the protective film was exposed was not substantially changed from that of the substrate with the multilayer reflective film and was equal to 65.7%.

The reflective mask thus obtained was subjected to ozone-water cleaning to be performed upon occurrence of haze. As a result, the reflectance for the EUV light in the reflective region was not substantially changed from the above-mentioned reflectance and was equal to 65.6%. Thus, it was confirmed that the reflective film had a sufficient resistance against the ozone-water cleaning also.

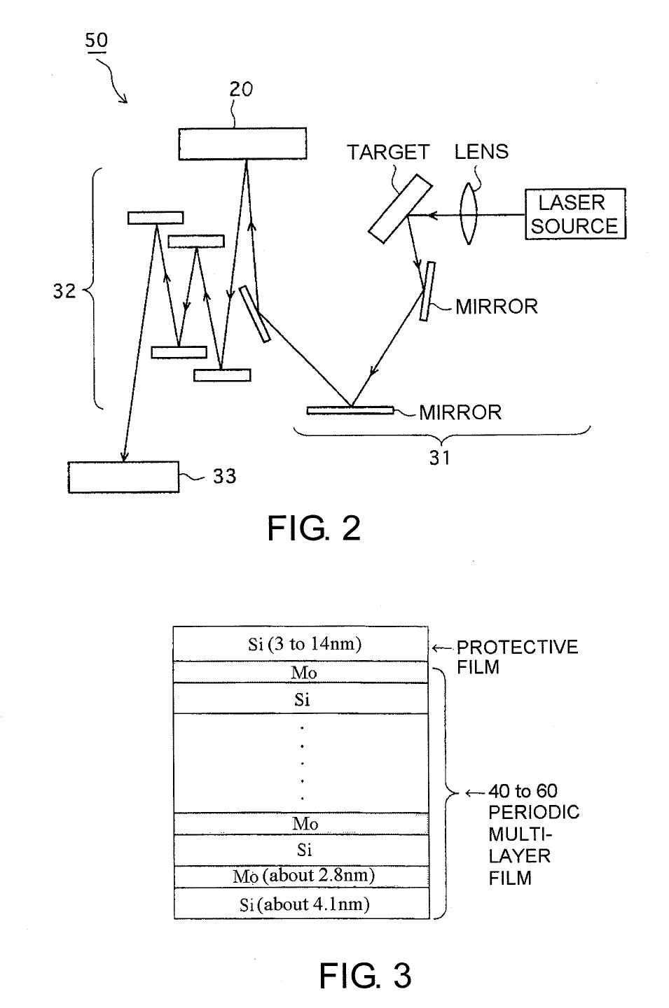

Then, using the reflective mask in this embodiment obtained as mentioned above, pattern transfer onto a semiconductor substrate by exposure with EUV light was performed by the use of a pattern transfer apparatus 50 illustrated in FIG. 2.

The pattern transfer apparatus 50 with the reflective mask mounted thereto comprises a laser plasma X-ray source 31, a reduction optical system 32, and so on. The reduction optical system 32 uses an X-ray reflection mirror. A pattern image formed by light reflected by the reflective mask 20 is generally reduced to about ¼. Since a wavelength band of 13 to 14 nm was used as an exposure wavelength, setting was preliminarily made so that an optical path was in vacuum.

In the above-mentioned state, the EUV light obtained from the laser plasma X-ray source 31 was incident to the reflective mask 20. The image formed by the light reflected by the reflective mask 20 was transferred by exposure onto a silicon wafer (semiconductor substrate with a resist layer) 33 through the reduction optical system 32.

The light incident to the reflective mask 20 was absorbed by the absorber film and was not reflected in an area where the absorber film pattern 4a (see FIG. 1D) was present. On the other hand, the light incident to another area where the absorber film pattern 4a was not present was reflected by the multilayer reflection film. Thus, the light reflected by the reflective mask 20 to form the image was incident to the reduction optical system 32. A transfer pattern was exposed onto the resist layer on the silicon wafer 33 by the light passing through the reduction optical system 32. By developing the resist layer thus exposed, a resist pattern was formed on the silicon wafer 33.

As mentioned above, pattern transfer onto the semiconductor substrate was performed. As a result, it was confirmed that the accuracy of the reflective mask in this embodiment was 16 nm or less as required in the 70 nm design rule.

Next, a comparative example will be described.

### COMPARATIVE EXAMPLE

In the manner similar to Example 1, Si films and Mo films were laminated on a substrate in 40 periods where a combination of a Si film having a thickness of 4.2 nm and a Mo film having a thickness of 2.8 nm was defined as a single period. Thereafter, a Si film was deposited to a thickness of 4.2 nm. Finally, an Ru film as a protective film was deposited to a thickness of 2.0 nm. Thus, a substrate with a multilayer reflective film was obtained. EUV light having a wavelength of 13.5 nm was incident to the multilayer reflective film at an incident angle of 6.0 degrees. As a result, the reflectance was 65.9%.

Next, using the above-mentioned substrate with a multilayer reflective film, a reflective mask blank and a reflective mask were produced in the manner similar to Example 1. The Ru protective film is low in etching resistance against an oxygen-rich chlorine-based gas. Therefore, the buffer film was dry etched by using a mixed gas of oxygen and chlorine with an oxygen content of 20%.

The reflective mask thus obtained was subjected to ozone-water cleaning to be performed upon occurrence of haze. As a result, the reflectance for the EUV light in the reflective region was further decreased by 1.4% as compared with the above-mentioned reflectance. Thus, it was confirmed that the resistance against ozone-water cleaning was insufficient.

As thus far been described, according to this invention, it is possible to obtain a mask blank which has a protective film made of a material forming an etching stopper against etching (dry etching) of an absorber film and a buffer film.

This invention is applicable not only to a mask blank and a mask for use in forming a pattern of a DRAM or the like but also to a mask blank and a mask for use in transfer of a pattern of various kinds of electronic devices, such as a TFT, by exposure.

What is claimed is:

1. A method of producing a reflective mask using a reflective mask blank comprising a substrate, a multilayer reflective film formed on the substrate to reflect exposure light, a protective film formed on the multilayer reflective film to protect the multilayer reflective film, a buffer film formed on the protective film and made of a material etchable during dry etching performed by the use of an etching gas containing an oxygen gas, and an absorber film formed on the buffer film to absorb the exposure light, wherein:
the protective film is made of a ruthenium compound containing ruthenium (Ru) and niobium (Nb);
the method including a step of patterning the buffer film by dry etching performed by the use of the etching gas containing the oxygen gas.

2. A method according to claim 1, wherein the protective film has a thickness within a range between 0.8 nm and 5 nm.

3. A method according to claim 1, wherein the buffer film is made of a chromium-based material containing chromium (Cr).

4. A method according to claim 3, wherein the buffer film is made of a material containing chromium nitride (CrN) as a main component.

5. A method according to claim 1, wherein the absorber film is made of a tantalum-based material containing tantalum (Ta).

6. A method according to claim 1, wherein the etching gas containing the oxygen gas is a mixed gas of a chlorine-based gas and the oxygen gas.

7. A method according to claim 2, wherein the buffer film is made of a chromium-based material containing chromium (Cr).
